(19) United States
(12) Patent Application Publication
(10) Pub. No.: US 2020/0250429 A1
(43) Pub. Date: Aug. 6, 2020

(54) ATTITUDE CALIBRATION METHOD AND DEVICE, AND UNMANNED AERIAL VEHICLE

(71) Applicant: SZ DJI TECHNOLOGY CO., LTD., Shenzhen (CN)

(72) Inventors: Qingbo LU, Shenzhen (CN); Chen LI, Shenzhen (CN); Lei ZHU, Shenzhen (CN); Xiaodong WANG, Shenzhen (CN)

(21) Appl. No.: 16/855,826

(22) Filed: Apr. 22, 2020

Related U.S. Application Data
(63) Continuation of application No. PCT/CN2017/107834, filed on Oct. 26, 2017.

(51) Int. Cl. G06K 9/00; B64C 39/02; B64D 47/08; G06K 9/46; G06K 9/62; H04N 5/225; G01P 3/44; G01C 9/02; G01C 25/00

(52) U.S. Cl. CPC G06K 9/00664; B64C 39/024; B64D 47/08; G06K 9/46; G06K 9/6201; B64C 2201/141; G01P 3/44; G01C 9/02; G01C 25/005; B64C 2201/127; H04N 5/2253

(57) ABSTRACT

A method of attitude calibration includes acquiring video data by a photographing device, obtaining rotation information of an initial measurement unit (IMU) in a time interval during which the video data is acquired, and determining a relative attitude between the photographing device and the IMU based the video data and the rotation information.

### CROSS-REFERENCE TO RELATED APPLICATION

This application is a continuation of International Application No. PCT/CN2017/107834, filed on Oct. 26, 2017, the entire content of which is incorporated herein by reference.

### TECHNICAL FIELD

The present disclosure relates to unmanned aviation vehicle (UAV) and, more particularly, to a method of performing attitude calibration and a related device.

### BACKGROUND

An image sensor generates images based on optical input such as an incident light impinging on the image sensors. When processing the images, it is also necessary to acquire the attitude of the image sensor, including, for example, the information for location, velocity and acceleration information of the image sensor. Usually, an inertia measurement unit (IMU) is used for detecting the attitude information of the image sensor. The attitude information provided by the IMU is usually based on the coordinate system of the IMU. However, it is often necessary to convert the output of attitude information from the coordinate system of the of the IMU into a coordinate system of the image sensor to obtain the attitude information of the image sensor. Due to the deviation or difference of the coordinate system of the IMU and the coordinate system of the image sensor, there are certain attitude relationships between the IMU and the image sensor. Therefore, the attitude relationship between the IMU and the image sensor needs to be calibrated to improve accuracy of the measurement.

The calibration of the attitude relationship between the IMU and the image sensor requires that the IMU be placed at a fixed position relative to the image sensor, and an assembly process is used to ensure that the coordinate axis of the image sensor and the IMU are aligned with each other.

However, it is often difficult to ensure that the coordinate axis of the image sensor and the IMU are aligned with each other. If the coordinate axis of the image sensor and the IMU are not aligned, the calibration result of the attitude relationship between the IMU and the image sensor will be inaccurate. If the calibration result is inaccurate, the IMU data will be un-usable, which will affect the post processing of images, such as anti-shake, simultaneous localization and mapping (SLAM).

### SUMMARY

Embodiments of the present disclosure provide an attitude calibration method, device, and an unmanned aerial vehicle to improve the accuracy of the relative attitude of a photographing apparatus and an inertial measurement unit.

A first aspect of the embodiments of the present disclosure provides a method of attitude calibration that includes acquiring video data by a photographing device, determining a relative attitude between the photographing device and an inertia measurement unit (IMU) based on rotation information of the IMU in a time interval during which the video data is acquired, and the video data.

A second aspect of the embodiments of the present disclosure provides an unmanned aerial vehicle (UAV). The UAV includes a body, a power system mounted on the body for providing flight power, a flight controller communicatively connected to the power system and is configured to control flight of the unmanned aerial vehicle, a photographing device configure to capture video data, an inertia measurement unit (IMU) configured to provide a rotation information of the IMU in a time interval during which the video data is acquired, and an attitude calibration device configured to determine a relative attitude between the photographing device and the IMU based on the rotation information and the video data.

### BRIEF DESCRIPTION OF THE DRAWINGS

FIG. 1 is a flowchart of a method of attitude calibration with improved calibration according to the embodiment of the present disclosure.

FIG. 2 is a schematic diagram of the structure of image data according to the embodiment of the present disclosure.

FIG. 3 is another schematic diagram of the structure of image data according to an embodiment of the present disclosure.

FIG. 4 is a flowchart of another method of attitude calibration with improved calibration according to an alternative embodiment of the present disclosure.

FIG. 5 is a flowchart of yet another method of attitude calibration with improved calibration according to an alternative embodiment of the present disclosure.

FIG. 6 is a flowchart of another method of attitude calibration with improved calibration according to an alternative embodiment of the present disclosure.

FIG. 7 is a flowchart of yet another method of attitude calibration with improved calibration according to an alternative embodiment of the present disclosure.

FIG. 8 is a flowchart of another method of attitude calibration with improved calibration according to an alternative embodiment of the present disclosure.

FIG. 9 is a schematic diagram of showing an attitude calibration apparatus according to an embodiment of the present disclosure.

FIG. 10 is a structural diagram of an unmanned aerial vehicle according to an embodiment of the present disclosure.

### DETAILED DESCRIPTION OF THE EMBODIMENTS

Nomenclatures and corresponding numerals used in the present disclosure are listed as follows for the convenience of making references. Such listing should not be construed as a limitation to the scope or spirit of the present disclosure.

| | |
|---|---|
| 20 Video Data | 21 Image Frame |
| 22 Image Frame | 31 Image frame |
| 32 Image frame | 90 Attitude calibration device |
| 91 Memory | 92 Processor |
| 100 Unmanned aerial vehicle | 107 Motor |
| 106 Propeller | 117 Electronic speed controller |
| 118 Flight Controller | 108 Sensor System |
| 110 Communication System | 102 Supporting equipment |
| 104 Photographing device | 112 Ground station |
| 114 Antenna | 116 Electromagnetic wave |

Detailed description of the present disclosure is described with reference to the drawings. It should be appreciated that the described embodiments are exemplary embodiments, and only part of rather than the entirety of the embodiments of the present disclosure. Any embodiments conceived by those skilled in the art enlightened by the teaching of the described embodiments should be within the scope of the present disclosure.

Embodiments of the present disclosure will be described with reference to the accompanying drawings, in which the same numbers refer to the same or similar elements unless otherwise specified.

As herein included, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. The terms “perpendicular,” “horizontal,” “left,” “right,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe some embodiments, instead of limiting the present disclosure. The term “and/or” used herein includes any suitable combination of one or more related items listed.

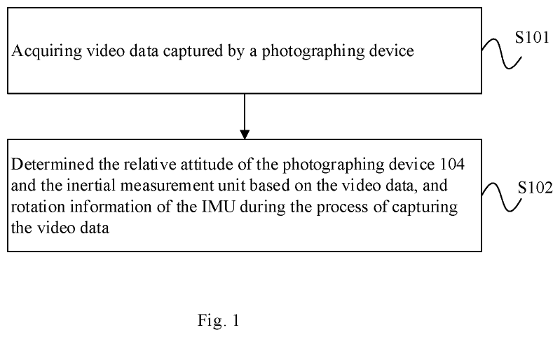

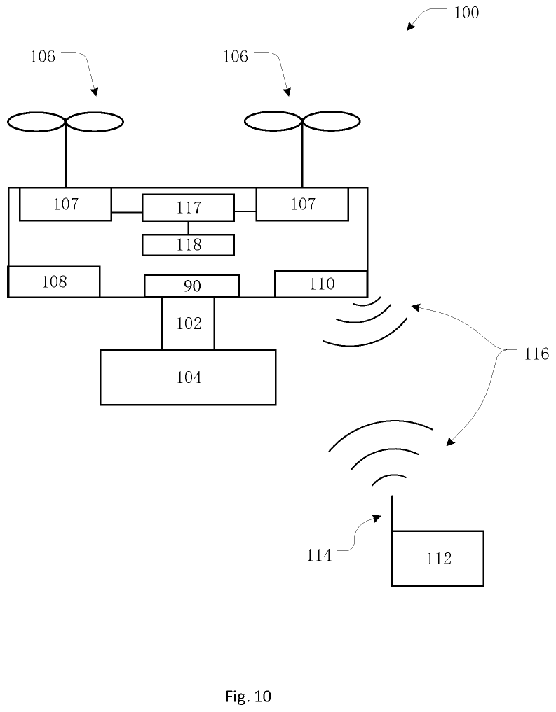

FIG. 1 is a flowchart showing a method of attitude calibration with improved calibration according to the embodiment of the present disclosure. Jointly referring to FIG. 1 and FIG. 10, the method in this embodiment may include step S101 which is acquiring image or video data captured by a photographing device.

The attitude calibration method described in this embodiment is applicable to an attitude between a photographing device enabled by an improved calibration method and an inertial measurement unit (IMU). The measurement result of the IMU indicates the attitude information of the IMU, and the attitude information of the IMU includes at least one of the following: an angular velocity of the IMU, a rotation matrix of the IMU, or a quaternion of the IMU. In some embodiments, the photographing device and the IMU are disposed on the same Printed Circuit Board (PCB), or the photographing device and the IMU are rigidly connected, and the relative attitude between the photographing device and the IMU is unknown.

The photographing device may be a device such as a camera or a camera. Generally, the internal parameter of the photographing device may be determined according to lens parameters of the photographing device, or an internal parameter of the photographing device may also be obtained by a calibration method. In this embodiment, the internal parameter of the photographing device is known. In some embodiments, the internal parameter of the photographing device includes at least one of the following: a focal length of the photographing device, and a pixel size of the photographing device. In addition, an output value of the IMU is an accurate value after calibration.

The photographing device is, for example, a camera, and the internal parameter of the camera is recorded as g in image coordinates [x, y]^{T}, and a light beam passing through the optical center of the camera is represented by [x′, y′, z′]^{T}. According to the follow equation (1), the light beam passing through the optical center of the camera can be represented by [x′, y′, z′]^{T} based on the internal parameter of the camera g and image coordinates [x, y]^{T}. Subsequently, according to equation (2), the image coordinates can be obtained from the beam passing through the optical center of the camera and the internal parameter of the camera.

[x′,y′,z′]^{T}=g([x,y]^{T}) (1)

[x,y]^{T}=g⁻¹([x′,y′,z′]^{T}) (2)

In this embodiment, the photographing device and the IMU may be disposed on a moving vehicle such as a drone or on a handheld gimbal and may also be disposed on other movable devices. The photographing device and the IMU can work at the same time, that is, the photographing device may detect target information while the IMU may detect its own attitude information, providing output of the measurement result. For example, the photographing device captures the first image frame at the moment the IMU provides output of the first measurement result.

For example, a target object is located at a distance of three meters from the photographing device. The photographing device starts capturing the video data of the target object from time t1 and ends the video capturing at time t2. Concurrently, the IMU detects the attitude information of the target from time t1. The IMU provides the measurement result as an output. By the time t2, the IMU ends detecting its own attitude information and stops providing the output of the measurement result. It can be seen that the video data of the target object from the time t1 to the time t2 can be obtained by the photographing device, and the attitude information of the IMU can be obtained by the IMU also from the time t1 to the time t2.

In step S102, the method according to the present disclosure may include determining a relative attitude of the photographing device and the inertial measurement unit based on the video data, and rotation information of the inertial measurement unit during the process of capturing the video data by the photographing device.

In this embodiment, the rotation information of the IMU during the period from t1 to t2 can be determined according to the measurement result provided by the IMU during the period from the time t1 to the time t2, during which the photographing device is in the process of capturing video data. Further, the relative position of the photographing device and the IMU is determined according to the video data captured by the photographing device and the rotation information of the IMU during the period from t1 to t2.

In some embodiments, the rotation information includes at least one of the following: a rotation angle, a rotation matrix, or a quaternion.

In some embodiments, the relative attitude of the photographing device and the inertial measurement unit may be determined based on the video data and the rotation information of the IMU, including: a predetermined number of frames separated by a first image frame and a second image frame in the video data, and the rotation information from a first exposure time of the first image frame to a second exposure time of the second image frame.

Assuming the video data captured by the photographing device during the period from t1 to t2 is recorded as the video data I, I may include the multi-image frames, with Iₖ representing the number k image frame of the video data I. In some embodiments, it can also be assumed that the sampling rate of the process of capturing the video data by of the photographing device is the number of frames of the image taken per second. At the same time, the IMU collects its own attitude information at its own frequency f_{w}, that is, the IMU outputs the measurement result at the frequency f_{w}. The measurement results of the IMU are recorded as ω, ω=w^{x} w^{y}, w^{z}), wherein w^{x}, w^{y}, w^{z} respectively are the three degrees of freedom. In some embodiments, f_{w} is greater than f_{I}, resulting with the number of image frames taken by the photographing device to be less than the number of measurement output by the IMU.

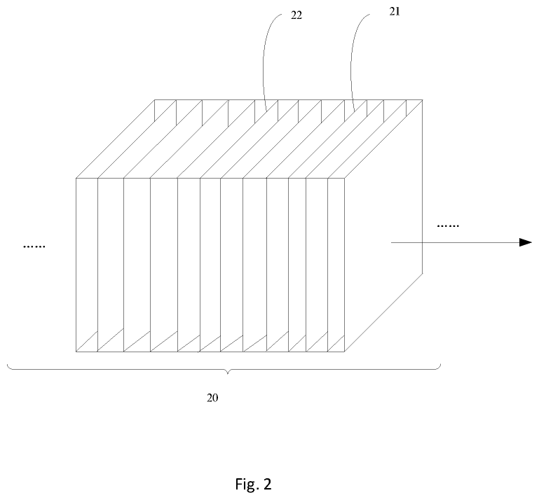

As shown in FIG. 2, 20 denotes video data, 21 denotes one image frame in the video data, and 22 denotes another image frame in the video data. This embodiment does not limit the number of image frames included in the video data. In the process of capturing the video data 20, the IMU outputs the measurement result at the frequency f_{w} of the IMU. The rotation information of the IMU in the process of the video data 20 may be determined based on the measurement result of the IMU output. Further, the rotation information of the photographing device and IMU in the process of capturing the video data 20 may be determined by the rotation information of the IMU during the process of capturing the video data 20.

As shown in FIG. 2, in this embodiment, it is assumed that the photographing device first captures the image frame 21, and then captures the image frame 22, and the image frame 21 and the image frame 22 are separated by a preset image frame. In some embodiments, the relative attitude relationship between the photographing device and IMU in the process of capturing the video data 20 may be determined by the rotation information of the IMU in the process. More specifically, the relative attitude relationship between the photographing device and IMU may be determined by the preset number of frames between the image frame 21 and the image frame 22 in the video data 20, and the time span of the first exposure time of image frame 21 to the second exposure time of the image frame 22 in the process of capturing the video data 20. It should be noted that the rotation information of the IMU from the first exposure time to the second exposure time is measured by the IMU between the first exposure time of the image frame 21 and the second exposure time of the image frame 22.

Without loss of generality, it is assumed that the image frame 21 is the number k image frame of the video data 20, and the image frame 22 is the number k+n image frame of the video data 20, wherein n≥1. That is to say, the image frame 21 and the image frame 22 are separated by n−1 number of frames of images. Assuming that the video data 20 includes m total number of frames of images, then it yields m>n, 1≤k≤m−n. Preferably, according to the video data 20 and the rotation information of the IMU in the process of capturing the video data 20 by the photographing apparatus 101, the relative attitude between the photographing device and the IMU may be determined as follows.

The relative attitude between the photographing device and the IMU may be determined by the rotation information of the IMU from the exposure time of number k image frame and the time of number k+n image frame during the video capturing process of video data 20, wherein 1<k≤m−n, or k=1 to m−n. For example, one can determine the relative attitude of the photographing device and the IMU based on the information of number one image frame and (1+n)-th image frame, and the rotation measurement of the IMU during the time span between the exposure moments of the first image frame and (1+n)-th image frame. Similarly, one can determine the relative attitude of the photographing device and the IMU based on the information of the second image frame and (2+n)-th image frame, and the rotation measurement of the IMU during the time span between the exposure moments the second image frame and image frame, so on and so forth. One can yield that by the end of this course, one can determine the relative attitude of the photographing device and the IMU based on the information of the (m−n)-th image frame and m-th image frame, and the rotation measurement of the IMU during the time span between the exposure moments (m−n)-th image frame and m-th image frame.

In this embodiment, as explained above, one can determine the relative attitude of the photographing device and the IMU based on the information of a first image frame a second image frame, and the rotation measurement of the IMU during the time span between the exposure moments of the first image frame and second image frame. The method may be implemented by the feasible implementation manners as follows.

In an embodiment according to the above method, the relative attitude of the photographing device and the IMU based on the information of a first image frame a second image frame, and the rotation measurement of the IMU during the time span between the exposure moments of the first image frame and second image frame, wherein the first image frame and second image frame are adjacent to each other.

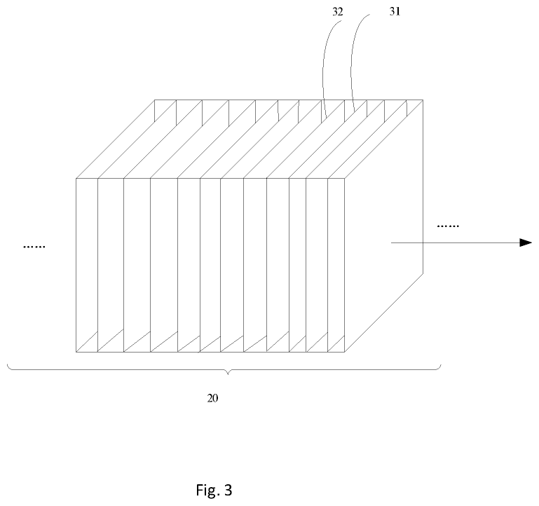

Referring to FIG. 3, In some embodiments, the first image frame and the second image frame in the video data separated by the predetermined number of frames may be adjacent to each other in the video data, for example, the image frame 21 and the image frame 22 separated by n−1 frames. When n=1, the image frame 21 represents the k-th image frame the video data 20, the image frame 22 represents (k+1)-th image frame of the video data 20. Therefore, the image frame 21 and the image frame 22 are adjacent two frames of images, as shown in FIG. 3. It is shown that the image frame 31 and the image frame 32 are adjacent two frames of images. Correspondingly, the relative attitude of the photographing device and the IMU based on the information of image frame 31 and image frame 32, and the rotation measurement of the IMU during the time span between the exposure moments of image frame 31 and second image frame 32, wherein image frame 31 and second image frame 32 are adjacent to each other.

Since the frequency of the IMU output measurement result is greater than the frequency of the image information collected by the photographing device, the IMU may output a plurality of measurement results during the exposure time of the adjacent two frames of images. Based on the plurality of measurement results of the IMU, the rotation information of the IMU in the time from the first exposure time of the image frame 31 to the second exposure time of the image frame 32 can be determined.

Without loss of generality, it is assumed that the image frame 31 is the number k image frame of the video data 20, and the image frame 32 is the number k+1 image frame of the video data 20, wherein image frames 31 and 32 are adjacent. Assuming that the video data 20 includes m total number of frames of images, it yields m>n, 1≤k≤m−1. In this embodiment, the relative attitude between the photographing device and the IMU may be determined according to the information in video data 20 and the rotation information of the IMU in the process of capturing the video data 20 as further explained below.

Still referring to FIG. 3, in an exemplary embodiment, one can determine the relative attitude of the photographing device and the IMU based on the information of k-th image frame and (k+1)-th image frame, and the rotation measurement of the IMU during the time span between the exposure moments of the k-th image frame and (k+1)-th image frame, wherein 1≤k≤m−1, or k is from 1 to m−1. For example, one can determine the relative attitude of the photographing device and the IMU based on the information of the first image frame and second image frame, and the rotation measurement of the IMU during the time span between the exposure moments the first image frame and the second image frame. Similarly, one can determine the relative attitude of the photographing device and the IMU based on the information of the second image frame and the third image frame, and the rotation measurement of the IMU during the time span between the exposure moments the second image frame and the third image frame, so on and so forth. One can yield that by the end of this course, one can determine the relative attitude of the photographing device and the IMU based on the information of the (m−1)-th image frame and m-th image frame, and the rotation measurement of the IMU during the time span between the exposure moments (m−1)-th image frame and m-th image frame.

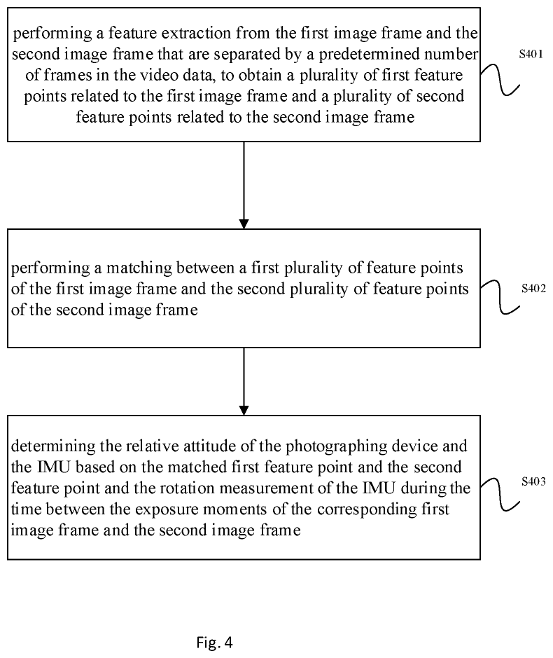

As shown in FIG. 4, the following steps S401-S403 provide more detailed description of the of method of attitude calibration with improved calibration according to an alternative embodiment of the present disclosure.

In Step S401, the method may include performing a feature extraction from the first image frame and the second image frame that are separated by a predetermined number of frames in the video data, to obtain a plurality of first feature points related to the first image frame and a plurality of second feature points related to the second image frame.

As shown in FIG. 2, the image frame 21 is the (k+n)-th image frame of the video data 20, the image frame 22 is the second image frame of the video data 20. The image frame 21 and the image frame 22 are separated by n−1 number of image frames, wherein n≥1. The present embodiment does not limit the predetermined number of frames of the images between the image frame 21 and the image frame 22, that is, the specific values are not limited. The image frame 21 can be recorded as a first image frame, and the image frame 22 can be recorded as a second image frame. It can be understood that there are multiple pairs of first image frames and second image frames separated by a predetermined number of frames in the video data 20.

Alternatively, using n=1 as an example, as shown in FIG. 3, the image frame 31 and the image frame 32 are adjacent two frames of images. The image frame 31 is the k-th image frame of the video data 20, and the image frame 32 is the (k+1)-th image frame of the video data 20. FIG. 3 is an exemplary exhibition of two adjacent frames of images. In some embodiments, the image frame 31 may be recorded as the first image frame, and the image frame 32 may be recorded as the second image frame. It can be understood that there are multiple pairs of adjacent first image frames and second image frames in the video data 20.

Specifically, feature extraction may be performed on each pair of the adjacent first image frames and second image frames by using a feature identification method to obtain the multiple first feature points of the first image frame and multiple second feature points of the second the second image frame. The feature identification method, in some embodiments, may include at least one of the following: a scale invariant feature transform (SIFT), a SURF algorithm, an ORB algorithm, or a Haar corner point. Assuming that the i-th feature point i-th of the kth image frame k-th is represented as D_{k,i} then D_{k,i}=(S_{k,i},[x_{k,i}, y_{k,i}]), wherein, i pertains to more than one value point, as can be understood, and S_{k,i} is the descriptor representing feature point i-th of the image frame k-th. The descriptor may include at least one of the following: a SIFT descriptor, an SUFR descriptor, an ORB descriptor, or an LBP descriptor. [x_{k,i}, y_{k,i}] represents the coordinate position of point i-th in the image frame k-th. Similarly, the coordinate position of point i-th in the image frame (k+1)-th can be represented as D_{k+1,i} and D_{k+1, i}=(S_{k+1,i}, [x_{k+1,i}, y_{k+1,i}]). In the present embodiment, there is not a specific limit set for the number of feature points of k-th image frame, and the number of feature points (k+1)-th.

In Step S402, the method may include performing a matching between a first plurality of feature points of the first image frame and a second plurality of feature points of the second image frame.

For example, matching is performed between a plurality of feature points of k-th image frame and a plurality of feature points of (k+1)-th image frame. One-on-one matched feature points between the k-th image frame and the k+1 image frame may be obtained after such matching, with any error matching points excluded. More specifically as an example, if i-th feature point D_{k,i} of the image frame k matches the i-th feature point D_{k+1,i} of the first image frame k+1, the matching relationship between the feature points can be expressed as Pₖⁱ=(D_{k,i}, D_{k+1,i}). It can be appreciated that i may take more than one value.

In step S403, the method further includes determining the relative attitude of the photographing device and the IMU based on the matched first feature point and the second feature point as described above and the rotation measurement of the IMU during the time span between the exposure moments of the corresponding first image frame and the second image frame.

It can be understood that there can be a plurality pairs of adjacent first image frames and second image frames in the video data 20. Correspondingly there can be a plurality pairs of matched feature points between the respective adjacent first image frames and the second image frames. As shown in FIG. 3, the image frame 31 is the k-th image frame of the video data 20, and the image frame 32 is the (k+1)-th image frame of the video data 20. Assuming that the exposure time of the k-th image frame is t^{k}, and the exposure time of the (k+1)-th image frame is tₖ₊₁, the IMU provides output of a plurality of measurement results from the exposure time of the k-th image frame to the exposure time of the (k+1)-th image frame. Then the rotation information of the IMU can be determined based on the measurement result of the IMU from the exposure time tₖ of the k-th mage frame to the exposure time tₖ₊₁ of the (k+1)-th image frame. Subsequently, the relative attitude of the photographing device and the IMU can be determined based on the matching feature points between the k-th image frame and (k+1)-th image frame and the rotation information of the IMU from time tₖ to time tₖ₊₁.

Alternatively, the photographing device may include a camera. Depending on the type of image sensors used by the camera, the exposure time of a certain frame of image, including the time from the first exposure time of the first image frame to the second exposure time of the second image frame and the rotation information of the inertial can be determined by using the method described as follows.

In one embodiment, the camera may use a global shutter sensor. In this case, different pixel lines of an image frame are exposed simultaneously. When the camera captures video data, the number of frames of images per second for capturing the video is f_{I}, that is, the time it takes for the camera to capture a frame of image is 1/f_{I}. Therefore, the start exposure time of k-th image frame is k/fl, that is tₖ=k/f_{I}. Similarly, the start exposure time of (k+1)-th image frame is tₖ₊₁=(k+1)/f_{I}. During the time period of [tₖ, tₖ₊₁], the IMU collects the attitude information of the IMU at a frequency of f_{w}. The attitude information of the IMU may include at least one of the following: the angular velocity of the IMU, the rotation matrix of the IMU, or the quaternion of the IMU. The rotation information of the IMU may include at least one of the following: rotation angle, rotation matrix, or quaternion. If the measurement result of the IMU is the angular velocity of the IMU, calculating product integral of the angular velocity of the IMU during [tₖ, tₖ₊₁] period of time yields the rotation angle of the IMU during this period of time [tₖ, tₖ₊₁]. If the measurement result of the IMU is the rotation matrix of the IMU, calculating product integral of the rotation matrix of the IMU during [tₖ, tₖ₊₁] period of time yields the rotation matrix of the IMU during this period of time [tₖ, tₖ₊₁]. If the measurement result of the IMU is the quaternion of the IMU, calculating product integral the quaternion of the IMU during [tₖ, tₖ₊₁] period of time yields the quaternion of the IMU during this period of time [tₖ, tₖ₊₁]. In some embodiments in this embodiment, calculating product integral the rotation matrix of the IMU during [tₖ, tₖ₊₁] period of time yields the rotation matrix of the IMU during this period of time [tₖ, tₖ₊₁] which can be denoted as R_{k,k+1}.

In another embodiment, the camera may use a rolling shutter sensor. In this case, different pixel lines of an image are exposed at different times. For example, within a frame of an image, the time required for the exposure from the first pixel line to the end of the last pixel line of exposure is T, assuming that the height of a frame of image is H. For a rolling shutter, the exposure time of a feature point also depends on the position of the feature point in the image. Assuming the position of the i-th feature point of the k-th frame image in the frame image in the coordinates is represented as [x_{k,i}, y_{k,i}], wherein x_{k,i} represents i-th feature point in the image width direction, y_{k,i}, represents the i-th feature point in the image height direction, one can have

$${t}_{k + 1 , i} = \frac{k + 1}{{f}_{I}} + \frac{{y}_{k + 1 , i}}{H} T .$$

Similarly, the exposure time of D_{k,i}'s matching feature point D_{k+1,i} is recorded as

$${t}_{k , i} , {t}_{k + 1 , i} = \frac{k + 1}{{f}_{I}} + \frac{{y}_{k + 1 , i}}{H} T .$$

During this period of time [t_{k,i}, t_{k+1,i}], the IMU may collect the attitude information of the IMU at a frequency of f_{w}. During the time period of [t_{k,i}, t_{k+1,i}], the IMU collects the attitude information of the IMU at a frequency of f_{w}. The attitude information of the IMU may include at least one of the following: the angular velocity of the IMU, the rotation matrix of the IMU, or the quaternion of the IMU. The rotation information of the IMU may include at least one of the following: rotation angle, rotation matrix, or quaternion. If the measurement result of the IMU is the angular velocity of the IMU, calculating product integral of the angular velocity of the IMU during [t_{k,i}, t_{k+1,i}] period of time yields the rotation angle of the IMU during this period of time [t_{k,i}, t_{k+1,i}]. If the measurement result of the IMU is the rotation matrix of the IMU, calculating product integral of the rotation matrix of the IMU during [t_{k,i}, t_{k+1,i}] period of time yields the rotation matrix of the IMU during this period of time [t_{k,i}, t_{k+1,i}]. If the measurement result of the IMU is the quaternion of the IMU, calculating product integral of the quaternion of the IMU during [t_{k,i}, t_{k+1,i}] period of time yields the quaternion of the IMU during this period of time [t_{k,i}, t_{k+1,i}]. In some embodiments in this embodiment, calculating product integral of the rotation matrix of the IMU during [t_{k,i}, t_{k+1,i}] period of time yields the rotation matrix of the IMU during this period of time [t_{k,i}, t_{k+1,i}] which can be denoted as R_{k, k+1}ⁱ.

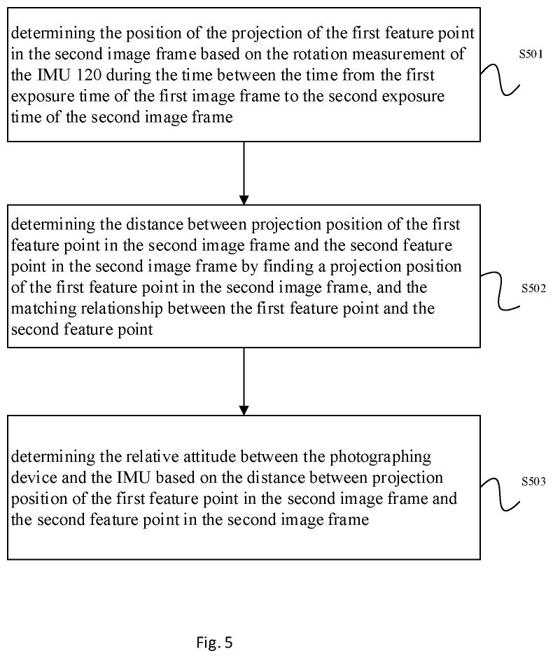

More specifically, referring to FIG. 5, steps S501-S503 as follows describe in more details of the method of determining the relative attitude of the photographing device and the IMU based on the information of the matched first feature point and second feature point, and the rotation measurement of the IMU during the time span between the time from the first exposure time of the first image frame to the second exposure time of the second image frame.

In Step S501, the method may include determining the position of the projection of the first feature point in the second image frame based on the rotation measurement of the IMU during the time span between the time from the first exposure time of the first image frame to the second exposure time of the second image frame.

For example, in an embodiment wherein it is assumed that the i-th feature point D_{k,i} of the k-th frame image matches the i-th feature point D_{k+1,i} of the (k+1)-th frame image, i-th feature point D_{k,i} of the k-th frame image is recorded as the first feature point, and the i-th feature point D_{k+1,i} of the (k+1)-th frame image is recorded as the second feature point. Then the projection position of the i-th feature point D_{k,i} of the k-th frame image being projected in the (k+1)-th frame image can be determined by the i-th feature point D_{k,i} of the k-th frame image and R_{k,k+1}, which is the rotation matrix of the IMU during [tₖ, tₖ₊₁]period of time, assuming the camera uses a global shutter sensor. When the camera uses a rolling shutter sensor, then the projection position of the i-th feature point D_{k,i} of the k-th frame image being projected in the (k+1)-th frame image can be determined by the i-th feature point D_{k,i} of the k-th frame image and R_{k,k+1}ⁱ, which is the rotation matrix of the IMU during [t_{k,i}, t_{k+1,i}] period of time.

That is to say, one can determine the projection position of the first feature point of the first frame image being projected in the second frame image based on the rotation measurement of the IMU during the time span between the exposure moments of the first image frame and second image frame. The above method may further include determining the projection position of a feature point of the first frame image being project in the second image frame according to the position of the first feature point in the first image frame, the rotation information of the IMU during the time span between the exposure moments of the first image frame and second image frame, the relative attitude between the photographing device and the IMU and internal parameters of the photographing device.

Specifically, assuming that the relative attitude of the photographing device and the IMU is recorded as [symbol] , it can be understood that rotation relationship between the coordinates of the camera and the coordinates of the IMU is [symbol] , the relative attitude of the photographing device and the IMU.

When the camera uses a global shutter sensor, according to the optical principles used in image photographing, the projection position of the i-th feature point D_{k,i} in the (k+1)-th frame image can be determined as g⁻¹ [symbol] R_{k,k+1}g([x_{k,i}, y_{k,i}]^{T})) based on the following assumption, that the position of i-th feature point D_{k,i} in the k-th frame image is [x_{k,i}, y_{k,i}], the exposure time at which the k-th frame being exposed is tₖ=k/f_{I}, the exposure time at which the (k+1)-th frame being exposed is tₖ₊₁=(k+1)/f_{I}, the rotation matrix of the IMU is R_{k,k+1} over a period of time of [tₖ, tₖ₊₁], the relative attitude of the photographing device and the IMU is [symbol] , the internal parameters of the photographing device is g.

When the camera uses a rolling shutter sensor, according to the optical principles used in image photographing, the projection position of the i-th feature point D_{k,i} in the (k+1)-th frame image can be determined as g⁻¹( [symbol] R_{k,k+1}ⁱ g([x_{k,i}, y_{k,i}]^{T})) based on the following assumptions that the position of i-th feature point D_{k,i}, in the k-th frame image is [x_{k,i}, y_{k,i}], the exposure time of D_{k,i} is

$${t}_{k , i} = \frac{k}{{f}_{I}} + \frac{{y}_{k , i}}{H} T ,$$

the exposure time of D_{k,i}'s matching feature point D_{k+1,i} is

$${t}_{k + 1 , i} = \frac{k + 1}{{f}_{I}} + \frac{{y}_{k + 1 , i}}{H} T ,$$

the rotation matrix of the IMU is R_{k, k+1}ⁱ over a period of time of [tₖ, tₖ₊₁], the relative attitude of the photographing device and the IMU is [symbol] , and the internal parameters of the photographing device is g.

In some embodiments, the internal parameters of the photographing device include at least one of the following: a focal length of the photographing device or a pixel size of the photographing device.

In step S502, the method according to the present disclosure may include determining the distance between the above described projection position of the first feature point in the second image frame and the second feature point in the second image frame by finding a projection position of the first feature point in the second image frame, and the matching relationship between the first feature point and the second feature point.

In the following embodiment, the relative attitude of the photographing device and the IMU is unknown. If the camera uses a global shutter sensor, given the correct [symbol] (the rotation relationship between the coordinates of the camera and the coordinates of the IMU), the following equation (3) holds. If the camera uses a rolling shutter sensor, given the correct 91, the following equation (4) holds.

[x_{k+1,i},y_{k+1,i}]^{T}=g⁻¹( [symbol] R_{k,k+1}g([x_{k,i},y_{k,i}]^{T})) (3)

[x_{k+1,i},y_{k+1,i}]^{T}=g⁻¹( [symbol] R_{k,k+1}ⁱg([x_{k,i},y_{k,i}]^{T})) (4)

That is, when [symbol] is given accurately, the distance between the projection position of the i-th feature point D_{k,i} in the (k+1)-th image frame and matching feature point D_{k,i} in the (k+1)-th image frame is 0 (zero) based on an assumption that projection position of the i-th feature point D_{k,i} in the (k+1)-th image frame and matching feature point D_{k,i} in the (k+1)-th image frame are overlap with each other.

However, in this embodiment [symbol] is unknown, which needs to be solved. In the case that [symbol] is unknown, if the camera uses a global shutter sensor, the distance between the projection position of the i-th feature point D_{k,i} in the (k+1)-th image frame and matching feature point D_{k,i} in the (k+1)-th image frame can be determined by equation (5). If the camera uses a rolling shutter sensor, the distance between the projection position of the i-th feature point D_{k,i} in the (k+1)-th image frame and matching feature point D_{k,i} in the (k+1)-th image frame can be determined by equation (6). wherein the distance in this embodiment can be presented in the system of

d([x_{k+1,i},y_{k+1,i}]^{T},g⁻¹( [symbol] R_{k,k+1}g([x_{k,i},y_{k,i}]^{T}))) (5)

d([x_{k+1,i},y_{k+1,i}]^{T},g⁻¹( [symbol] R_{k,k+1}ⁱg([x_{k,i},y_{k,i}]^{T}))) (6)

It is noted that in this embodiment, the distance includes at least one of the following: a European distance, a city distance, or a Mahalanobis distance.

In step S503, the method according to the present disclosure may include determining the relative attitude between the photographing device and the IMU based on the distance between the above described projection position of the first feature point in the second image frame and the second feature point in the second image frame.

In the following embodiment, determining the relative attitude between the photographing device and the IMU based on the distance between the projection position of the first feature point and the second feature point in the second image frame includes calculating optimization on the distance between the feature points to determine the relative attitude between the photographing device and the IMU.

In equation (5), for which the camera uses a global shutter sensor, the relative attitude [symbol] of the photographing device and the IMU is unknown and needs to be solved. Because if [symbol] is accurate to its true value, the distance between the projection position of the i-th feature point D_{k,i} of the k-th image projected in the (k+1)-th image frame and the matching feature point D_{k,i} in the (k+1)-th image frame would be zero (0). That is, the distance d represented by equation (6) is 0. Vice versa, if a value for [symbol] can be found, using equation (5), so that the distance between the projection position of the i-th feature point D_{k,i} of the k-th image projected in the (k+1)-th image frame and the matching feature point D_{k,i} in the (k+1)-th image frame to be the least of value, such as zero (0), then the value R is the value that minimizes the distance d.

Similarly, in equation (6), for which the camera uses a rolling shutter sensor, the relative attitude [symbol] of the photographing device and the IMU is unknown and needs to be solved. Since if [symbol] is accurate to its true value, the distance between the projection position of the i-th feature point D_{k,i} of the k-th image projected in the (k+1)-th image frame and the matching feature point D_{k,i} in the (k+1)-th image frame would be zero (0). That is, the distance d represented by formula (5) is 0. Vice versa, if a value for [symbol] can be found, using equation (5), so that the distance between the projection position of the i-th feature point D_{k,i} of the k-th image projected in the (k+1)-th image frame and the matching feature point D_{k,i} in the (k+1)-th image frame to be the least of value, such as zero (0), then the value R is the value that minimizes the distance d.

The above described method of determining the relative attitude of the photographing device and the IMU by using the optimization of distance between the projection position and the second feature point may include determining the relative attitude of the photographing device and the IMU by using the smallest distance between the projection position and the second feature point.

That is, by calculating optimization of equation (5), one can obtain the relative attitude [symbol] of the photographing device and the IMU that yields d to be the minimum value, and therefore determine the relative attitude [symbol] of the photographing device and the IMU. Or by calculating optimization of equation (6), one can obtain the relative attitude [symbol] of the photographing device and the IMU that yields d to be the minimum value, and therefore determine the relative attitude [symbol] of the photographing device and the IMU.

It can be understood that, without loss of generality, there are a plurality pairs of adjacent first image frames and second image frames in the video data 20, and there are not only one pair of corresponding matching feature points of the adjacent first image frames and the second image frames. If the camera uses a global shutter sensor, the relative attitude [symbol] of the photographing device and the IMU can be determined by the following equation (7). If the camera uses a rolling shutter sensor, the relative attitude [symbol] of the photographing device and the IMU can be determined by the following equation (7). (8):

[symbol]

=arg [symbol] ΣₖΣᵢd([x_{k+1,i},y_{k+1,i}]^{T},g⁻¹( [symbol] R_{k,k+1}g([x_{k,i},y_{k,i}]^{T}))) (7)

[symbol]

=arg [symbol] ΣₖΣᵢd([x_{k+1,i},y_{k+1,i}]^{T},g⁻¹( [symbol] R_{k,k+1}g([x_{k,i},y_{k,i}]^{T}))) (8)

wherein k denotes to the k image frame in the video data, i denotes to the i feature point.

In addition, there may be multiple equivalent forms of equation (7), such as shown in, but not limited to, equations (9), (10), and (11).

$$\begin{matrix}= arg {\sum }_{k} {\sum }_{i} d ( g ( {[ {x}_{k + 1 , i} , {y}_{k + 1 , i} ]}^{T} ) , {R}_{k , k + 1} g ( {[ {x}_{k , i} , {y}_{k , i} ]}^{T} ) ) & ( 9 ) \\ = arg {\sum }_{k} {\sum }_{i} d ( {- 1}^{} g ( {[ {x}_{k + 1 , i} , {y}_{k + 1 , i} ]}^{T} ) , {R}_{k , k + 1} g ( {[ {x}_{k , i} , {y}_{k , i} ]}^{T} ) ) & ( 10 ) \\ = ar {\sum }_{k} {\sum }_{i} d ( {R}_{k , k + 1}^{- 1} {- 1}^{} g ( {[ {x}_{k + 1 , i} , {y}_{k + 1 , i} ]}^{T} ) , g ( {[ {x}_{k , i} , {y}_{k , i} ]}^{T} ) ) & ( 11 )\end{matrix}$$

In addition, there are many equivalent forms of formula (8), such as shown in, but not limited to equations (12), (13), and (14).

$$\begin{matrix}= arg {\sum }_{k} {\sum }_{i} d ( g ( {[ {x}_{k + 1 , i} , {y}_{k + 1 , i} ]}^{T} ) , {R}_{k , k + 1}^{i} g ( {[ {x}_{k , i} , {y}_{k , i} ]}^{T} ) ) & ( 12 ) \\ = arg {\sum }_{k} {\sum }_{i} d ( {- 1}^{} g ( {[ {x}_{k + 1 , i} , {y}_{k + 1 , i} ]}^{T} ) , {R}_{k , k + 1}^{i} g ( {[ {x}_{k , i} , {y}_{k , i} ]}^{T} ) ) & ( 13 ) \\ = arg {\sum }_{k} {\sum }_{i} d ( {( {R}_{k , k + 1}^{i} )}^{- 1} {- 1}^{} g ( {[ {x}_{k + 1 , i} , {y}_{k + 1 , i} ]}^{T} ) , g ( {[ {x}_{k , i} , {y}_{k , i} ]}^{T} ) ) & ( 14 )\end{matrix}$$

In the above described embodiment, the rotation information of the IMU is determined according to the measurement results of the IMU during the photographing process of the video data done by photographing device. Since both the video data and the measurement results of the IMU can be substantially accurately obtained, therefore using the video data and the rotation information of the IMU to determine the relative attitude of the photographing device and the inertial measurement unit relatively may achieve desirable accuracy in comparison to those method in the existing practice. In comparison, the existing practices rather focus on achieving the alignment of the coordinate axes of the image sensor (the photographing device) and the IMU in order to determine the relative attitude of the IMU and image sensor. The present disclosure improves the accuracy of the relative attitude and avoids the problem that the IMU data being not useable due to the inaccurate relative alignment of the IMU and the image sensor, which affects the post-processing of the image.

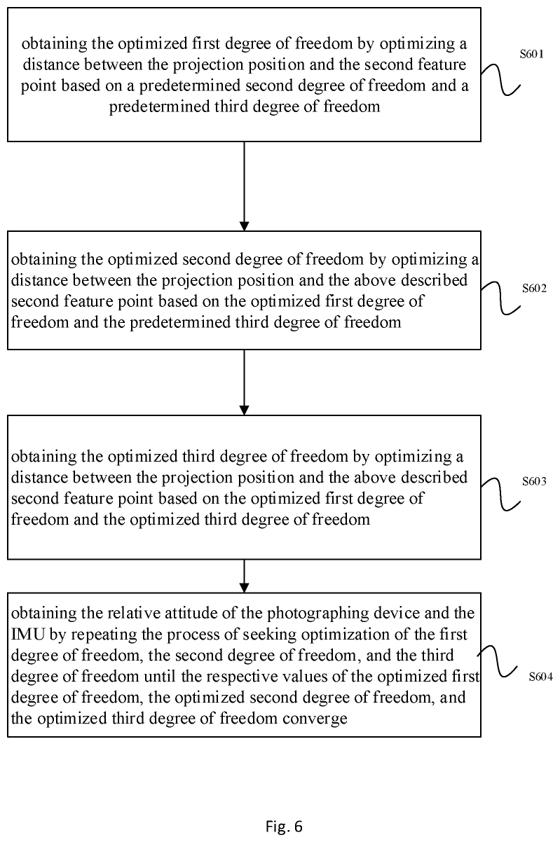

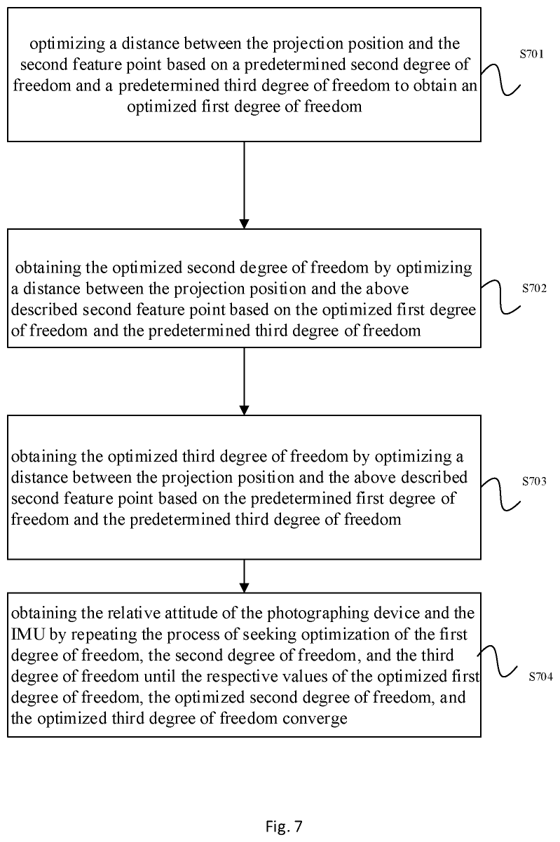

The present disclosure provides the method of making attitude calibration. FIG. 6 is a flowchart of an alternative method of attitude calibration with improved calibration according to an alternative embodiment of the present disclosure. FIG. 7 is a flowchart of yet another method of attitude calibration with improved calibration according to an alternative embodiment of the present disclosure.

Based on the embodiment shown in FIG. 1, the relative attitude of the photographing device and the IMU include a first degree of freedom, a second degree of freedom, and a third degree of freedom. For example, the relative attitude [symbol] of the photographing device and the IMU includes a first degree of freedom recorded as α, a second degree of freedom recorded as β, and a third degree of freedom recorded as γ. That is, [symbol] can be expressed as [symbol] (α, β, γ). After [symbol] being brought into any of the above formulas (7) to (14), a correspondingly transformed equation can be obtained. Taking equation (8) as an example, after [symbol] (α, β, γ) is brought into equation (8), equation (8) can be transformed into equation (15):

[symbol]

=arg min_{α,β,γ}d([x_{k+1,i},y_{k+1,i}]^{T},g⁻¹( [symbol] (α,β,γ)R_{k,k+1}ⁱg([x_{k,i},y_{k,i}]^{T}))) (15)

Equation (15) can be further transformed into equation (16):

[symbol]

=arg min_{α} min_{β} min_{γ}ΣₖΣᵢd([x_{k+1,i},y_{k+1,i}]^{T},g⁻¹( [symbol] (α,β,γ)R_{k,k+1}ⁱg([x_{k,i},y_{k,i}]^{T}))) (16)

As above described embodiment according to the present disclosure, the method of determining the relative attitude of the photographing device and the IMU by optimizing the distance between the projection position and the second feature point. Detailed embodiment method includes the following described steps S601 to S604 shown in FIG. 6:

In Step S601, the method may include obtaining the optimized first degree of freedom by optimizing a distance between the projection position and the above described second feature point based on a predetermined second degree of freedom and a predetermined third degree of freedom.

In equation (16), [x_{k,i}, y_{k,i}]^{T} [symbol] R_{k,k+1}ⁱ [symbol] g are known and [symbol] (α, β, γ) is unknown in this embodiment. Accordingly, one can then solve, [symbol] (α, β, γ) using the first degree of freedom α, a second degree of freedom β, and a third degree of freedom γ based on the assumption that there are respective predetermined values for the first degree of freedom α, a second degree of freedom β, and a third degree of freedom γ. For example, the initial value of the first degree of freedom α is α0, the initial value of the second degree of freedom β is β0, and the initial value of the third degree of freedom γ is γ0.

One can then obtain the optimal first degree of freedom α1 by solving equation (16) according to the initial value of the second degree of freedom β0 and the initial value of the third degree of freedom γ0.

In step S602, the method may include obtaining the optimized second degree of freedom by optimizing a distance between the projection position and the above described second feature point based on the optimized first degree of freedom and the predetermined third degree of freedom.

Accordingly, one can then solve equation (16) to obtain β1 by using the optimized first degree of freedom α1 obtained in step S601 and the predetermined third degree of freedom γ, that is the initial value of the third degree of freedom γ0.

In step S603, the method may include obtaining the optimized third degree of freedom by optimizing a distance between the projection position and the above described second feature point based on the optimized first degree of freedom and the optimized third degree of freedom.

Accordingly, the optimized third degree of freedom γ1 can be obtained by solving the equation (16) based on the optimized first degree of freedom α1 obtained in step S601 and the optimal second degree of freedom β1 obtained in step S602.

In step S604, the method may include obtaining the relative attitude of the photographing device and the IMU by repeating the process of calculating optimization of the first degree of freedom, the second degree of freedom, and the third degree of freedom until the respective values of the optimized first degree of freedom, the optimized second degree of freedom, and the optimized third degree of freedom converge.

In steps S601-S603 one can obtain the optimized first degree of freedom α1, the optimized second degree of freedom β1 and the optimized third degree of freedom γ1. Further, returning back to step 601, one can solve equation (16) to obtain the optimized first degree of freedom α2 based on the optimized second degree of freedom β1 and the third degree of freedom γ1 obtained in step S602.

In step S604, the method may include obtaining the relative attitude of the photographing device and the IMU by repeating the process of calculating optimization of the first degree of freedom, the second degree of freedom, and the third degree of freedom until the respective values of the optimized first degree of freedom, the optimized second degree of freedom, and the optimized third degree of freedom converge.

In steps S601-S603 one can obtain the optimized first degree of freedom α1, the optimized second degree of freedom β1 and the optimized third degree of freedom γ1. Further, returning back to step 601, one can solve equation (16) to obtain the optimized first degree of freedom α2 based on the optimized second degree of freedom β1 and the third degree of freedom γ1. Then repeating step S602, one can then solve equation (16) to obtain β2 by using the optimized first degree of freedom α2 and the optimized third degree of freedom γ1. Repeating step 603, optimized third degree of freedom γ2 can be obtained by solving the equation (16) based on the optimized first degree of freedom α2 and the optimal second degree of freedom β2. It can be seen that with every cycle of the steps S601-S603 executed, the optimal first degree of freedom, the optimal second degree of freedom, and the optimal third degree of freedom are updated once. By consecutively repeating the cycles of steps S601-S603, the optimal first degree of freedom, the optimal second degree of freedom, and the optimal third degree of freedom gradually converge to their respective values. In this embodiment, steps S601-S603 can be repeatedly executed until the optimal first degree of freedom, the optimal second degree of freedom, and the optimal third degree of freedom converge. Finally obtained in this embodiment are the optimal first degree of freedom, the optimal second degree of freedom, and the optimal third degree of freedom, respectively taken as the first degree of freedom α, the second degree of freedom β, and the third degree of freedom γ. The converged values of the first degree of freedom, the optimal second degree of freedom, and the optimal third degree of freedom can be determined as the solution of [symbol] (α, β, γ), and recorded as [symbol] (α, β, γ).

FIG. 7 shows another embodiment method in step S701-step S704 described as follows.

In step S701, the method according to the present disclosure may include optimizing a distance between the projection position and the second feature point based on a predetermined second degree of freedom and a predetermined third degree of freedom to obtain an optimized first degree of freedom.

In equation (16), [x_{k,i}, y_{k,i}]^{T} [symbol] R_{k,k+1}ⁱ [symbol] g are known and [symbol] (α, β, γ) is [symbol] unknown in this embodiment. Accordingly, one can then solve, [symbol] × (α, β, γ) using the first degree of freedom α, a second degree of freedom β, and a third degree of freedom γ based on the assumption that there are respective predetermined values for the first degree of freedom α, a second degree of freedom β, and a third degree of freedom γ. For example, the initial value of the first degree of freedom α is α0, the initial value of the second degree of freedom β is β0, and the initial value of the third degree of freedom γ is γ0.

One can then obtain the optimal first degree of freedom α1 by solving equation (16) according to the initial value of the second degree of freedom β0 and the initial value of the third degree of freedom γ0.

In step S702, the method may include obtaining the optimized second degree of freedom by optimizing a distance between the projection position and the above described second feature point based on the optimized first degree of freedom and the predetermined third degree of freedom.

Accordingly, one can then solve equation (16) to obtain β1 by using the predetermined first degree of freedom α0 obtained in step S601 and the predetermined third degree of freedom γ0, that is the initial value of the third degree of freedom γ0.

In step S703, the method may include obtaining the optimized third degree of freedom by optimizing a distance between the projection position and the above described second feature point based on the predetermined first degree of freedom and the predetermined third degree of freedom.

Accordingly, the optimized third degree of freedom γ1 can be obtained by solving the equation (16) based on the initial first degree of freedom α0 and the initial second degree of freedom β0.

In step S704, the method may include obtaining the relative attitude of the photographing device and the IMU by repeating the process of calculating optimization of the first degree of freedom, the second degree of freedom, and the third degree of freedom until the respective values of the optimized first degree of freedom, the optimized second degree of freedom, and the optimized third degree of freedom converge.

In steps S701-S703 one can obtain the optimized first degree of freedom α1, the optimized second degree of freedom β1 and the optimized third degree of freedom γ1. Further, returning back to step 701, one can solve equation (16) to obtain the optimized first degree of freedom α2 based on the optimized second degree of freedom β1 and the third degree of freedom γ1. Repeating step 702, one can then solve equation (16) to obtain β2 by using the optimized first degree of freedom α2 and the optimized third degree of freedom γ1. Repeating step 703, optimized third degree of freedom γ2 can be obtained by solving the equation (16) based on the optimized first degree of freedom α2 and the optimal second degree of freedom β2. It can be seen that with every cycle of the steps S701-S703 executed, the optimal first degree of freedom, the optimal second degree of freedom, and the optimal third degree of freedom are updated once. By consecutively repeating the cycles of steps S701-S703, the optimal first degree of freedom, the optimal second degree of freedom, and the optimal third degree of freedom gradually converge to their respective values. In this embodiment, steps S701-S703 can be repeatedly executed until the optimal first degree of freedom, the optimal second degree of freedom, and the optimal third degree of freedom converge. Finally obtained in this embodiment are the optimal first degree of freedom, the optimal second degree of freedom, and the optimal third degree of freedom, respectively taken as the first degree of freedom α, the second degree of freedom β, and the third degree of freedom γ. The converged values of the first degree of freedom, the optimal second degree of freedom, and the optimal third degree of freedom can be determined as the solution of [symbol] (α, β, γ), and recorded as [symbol] (α, β, γ).

In some embodiments, the first degree of freedom, the second degree of freedom, and the third degree of freedom may be respectively used to represent Euler angle components of IMU. Alternatively, the first degree of freedom, the second degree of freedom and the third degree of freedom may be respectively used to represent the previously described axial angle components of IMU. Further alternatively, the first degree of freedom, the second degree of freedom, and the third degree of freedom may be used to represent the quaternion components of IMU as previously described.

The embodiments herein presented according to the present disclosure provide the solutions of obtaining the relative attitude of the photographing device and the IMU by solving the first, second, and third degrees of freedom, calculating optimization in reiteration of the first degree of freedom, second degree of freedom and third degree of freedom, until the optimizations converge. This improves the accuracy of the relative attitude of the photographing device and the IMU.

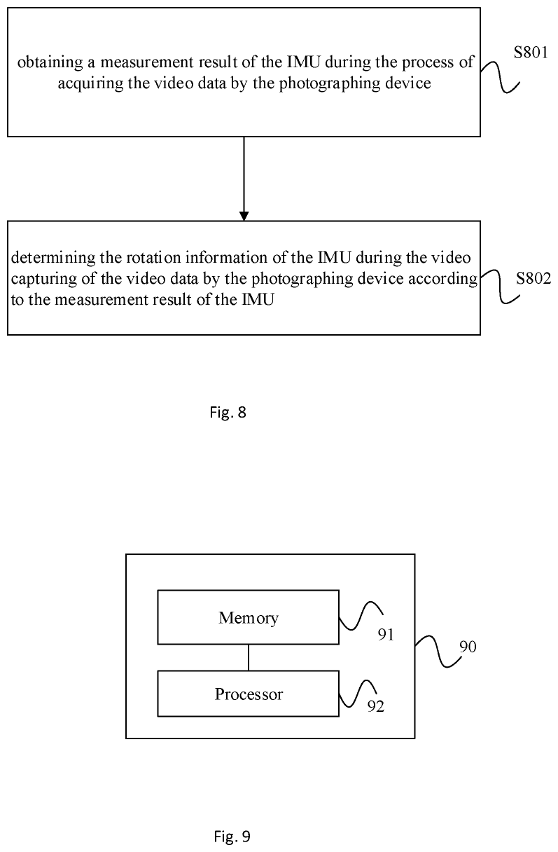

FIG. 8 is a flowchart of an attitude calibration method according to an alternative embodiment of the present disclosure. Based on the embodiments above described and after acquiring the video data captured by the photographing device, the method shown in FIG. 8 may include the steps as follows.

In step S801 the method may include obtaining a measurement result of the IMU during the process of acquiring the video data by the photographing device.

In this embodiment, the measurement result of the IMU may be the attitude information of the IMU, which may include at least one of the following: the angular velocity of the IMU, the rotation matrix of the IMU, or the quaternion of the IMU.

Alternatively, one may assume that the IMU acquires the angular velocity of the IMU at a first frequency and the photographing device acquires image information at a second frequency during the process of capturing video data, wherein the first frequency is greater than the second frequency.

For example, the sampling frame rate of the image information during shooting video data by the photographing device may be f_{I}. That is, the number of frames per second that the photographing device takes when shooting video data is f_{I}. At the same time, the IMU may collect its own attitude information such as angular velocity at a frequency of f_{w}. That is, the IMU outputs the measurement result at a frequency f_{w}, f_{w} is greater than f_{I}. That is to say, in the same time, the number of image frames captured by the photographing device is smaller than the number of measurement results output by the IMU.

In step S802, the method may include determining the rotation information of the IMU during the video capturing of the video data by the photographing device according to the measurement result of the IMU.

For example, the rotation information of the IMU during the process of capturing the video data 20 may be determined according to the measurement results output by the IMU during the process of capturing the video data 20.

Specifically, determining the rotation information of the IMU during the capturing of the video data by the photographing device may be conducted based on the measurement result of the IMU which may be achieved by calculating integral of measurement results of the IMU from the first exposure of the first image frame to the second exposure time of the second image frame.

The attitude information of the IMU may include at least one of the following: the angular velocity of the IMU, the rotation matrix of the IMU, or the quaternion of the IMU. The rotation information of the IMU may include at least one of the following: rotation angle, rotation matrix, or quaternion. If the measurement result of the IMU is the angular velocity of the IMU, calculating integral of the angular velocity of the IMU during [tₖ, tₖ₊₁] period of time yields the rotation angle of the IMU during this period of time [tₖ, tₖ₊₁].

More specifically, determining the rotation information of the IMU during the capturing of the video data by the photographing device may be conducted based on the measurement result of the IMU which may be achieved by calculating integral of measurement results of the IMU from the first exposure of the first image frame to the second exposure time of the second image frame. The detailed method of implement may include calculating integral of the angular velocity of the IMU from the first exposure time of the first image frame to the second exposure time of the second image frame.

For example, the start exposure time of k-th image frame is k/f_{I}, that is tₖ=k/f_{I}. Similarly, the start exposure time of (k+1)-th image frame is tₖ₊=(k+1)/f_{I}. If the measurement result of the IMU is the rotation matrix of the IMU, calculating product integral of the rotation matrix of the IMU during [tₖ, tₖ₊₁] period of time yields the rotation matrix of the IMU during this period of time [tₖ, tₖ₊₁].

Alternatively, if the measurement result of the IMU is the quaternion of the IMU, the start exposure time of k-th image frame is k/f_{I}, that is tₖ=k/f_{I}. Similarly, the start exposure time of (k+1)-th image frame is tₖ₊₁=(k+1)/f_{I}. Calculating product integral the quaternion of the IMU during [tₖ, tₖ₊₁] period of time yields the quaternion of the IMU during this period of time [tₖ, tₖ₊₁].

In addition, it should be noted that the methods of determining the rotation information of the IMU is not limited to the above described, and all variations are within the scope of the present disclosure.

The embodiments herein presented provide the solutions for obtaining the measurement results of the IMU during the process of recording video data by calculating integral of the measurement results of the IMU unit during the process of recording video data. Because measurement results of the IMU can be accurately obtained, the calculation of the integral of the measurement results of the IMU can yield accurate rotation information of the IMU.

FIG. 9 is a schematic diagram of showing an attitude calibration apparatus according to an embodiment of the present disclosure. As shown in FIG. 9, the attitude calibration device 90 may include a memory 91 and a processor 92. The memory 91 may be used to store program code. The processor 92 calls the program code. When the program code is executed, it causes following operations: obtaining video data captured by a photographing device; determining the relative attitude of the photographing device and the IMU according to the video data and the rotation information of the inertial measurement unit during the capturing of the video data.

In some embodiments, the rotation information may include at least one of the following: a rotation angle, a rotation matrix, or a quaternion.

The processor 92 determines the relative attitude of the photographing device and the IMU according to the video data and the rotation information of the IMU during the shooting of the video data. More specifically, the processor 92 is configured to determine the relative attitude of the photographing device and the IMU according to the first image frame and second image frame separated by a predetermined number of frames in the video data and the rotation information of the IMU from the exposure time of the first image frame to the exposure time of the second image frame of the video data.

Specifically, the processor 92 performs functions including a feature extraction from the first image frame and the second image frame that are separated by a predetermined number of frames in the video data, to obtain a plurality of first feature points related to the first image frame and a plurality of second feature points related to the second image frame.

The processor 92 determines the relative attitude of the photographing device and the IMU based on the information in the first image frame and the second image frame separated by a predetermined number of frames in the video data, and the rotation information obtained by the IMU during the time interval from the first exposure time of the first image frame to the second exposure time of the second image frame. More specifically, a feature extraction from the first image frame and the second image frame that are separated by a predetermined number of frames in the video data is conducted. The processor 92 acquires a plurality of first feature points related to the first image frame and a plurality of second feature points related to the second image frame feature extraction to obtain a plurality of first feature points of the first image frame and a plurality of second feature points of the second image frame. The processor 92 performs a matching between the first plurality of feature points of the first image frame and the second plurality of feature points of the second image frame. Processor 92 determines the relative attitude of the photographing device and the IMU based on the matched first feature point in the first image frame and second feature point in the second image frame, and the rotation information of the IMU during the time from the first exposure time to the second exposure time of the second image frame.

In some embodiments, the processor 92 determining the position of the projection of the first feature point in the second image frame based on the rotation measurement of the IMU during the time span between the time from the first exposure time of the first image frame to the second exposure time of the second image frame.

In some embodiments, processor 92 determines the projection position of the first feature point of the first frame image being projected in the second frame image based on the rotation measurement of the IMU during the time span between the exposure moments of the first image frame and second image frame. Processor 92 may determine the relative attitude between the photographing device and the IMU and internal parameters of the photographing device based on the projection position of a feature point of the first frame image being project in the second image frame according to the position of the first feature point in the first image frame, the rotation information of the IMU during the time span between the exposure moments of the first image frame and second image frame.

In some embodiments, the intrinsic parameters of the photographing device include at least one of the following: a focal length of the photographing device and a pixel size of the photographing device.

In some embodiments, the processor 92 may determine the relative attitude of the photographing device and the IMU according to a distance between the position of the projection of the first feature point in the second image frame and position of second feature point. More specifically the processor 92 may be configured to determine the distance between the position of projection point and the second feature point by optimizing the distance between the position of the projection point and the second feature point.

In some embodiments, the processor 92 may determine the relative attitude of the photographing device and the IMU according to a distance between the position of the projection of the first feature point in the second image frame and position of second feature point. More specifically, the processor 92 is configured to the optimize the distance which is to seek the smallest distance between the projection position of the first feature point in the second image frame and the second feature point in the second image frame.

The specific principles and implementation of the attitude calibration device provided by the embodiments of the present invention are similar to the embodiment described in association with FIG. 1. Repetition is not elaborated here.

In the above described embodiment, the rotation information of the IMU is determined according to the measurement results of the IMU during the photographing process of the video data done by photographing device. Since both the video data and the measurement results of the IMU can be substantially accurately obtained, therefore using the video data and the rotation information of the IMU to determine the relative attitude of the photographing device and the inertial measurement unit relatively may achieve desirable accuracy in comparison to those method in the existing practice. In comparison, the existing practices rather focus on achieving the alignment of the coordinate axes of the image sensor (the photographing device) and the IMU in order to determine the relative attitude of the IMU and image sensor. The present disclosure improves the accuracy of the relative attitude and avoids the problem that the IMU data being not useable due to the inaccurate relative alignment of the IMU and the image sensor, which affects the post-processing of the image.

An embodiment of the present invention provides an attitude calibration device, shown in FIG. 9, that measures relative attitude of the photographing device, including a first degree of freedom, a second degree of freedom, and a third degree of freedom.

In some embodiments, the processor 92 may seek optimization of the distance between the position of the projection of the first feature point in the second image frame and position of second feature point. More specifically, the processor 92 is configured to optimized first degree of freedom by optimizing a distance between the projection position and the above described second feature point based on a predetermined second degree of freedom and a predetermined third degree of freedom. Based on the optimized first degree of freedom degree of freedom, obtain the optimized second degree of freedom by optimizing a distance between the projection position and the above described second feature point based on the optimized first degree of freedom and the predetermined third degree of freedom. Based on the optimized first degree of freedom and optimized second degree of freedom, processor 92 may be configured to optimize the distance between the projection position and the second feature point to obtain an optimized third degree of freedom. So on and so forth, the first degree of freedom, the second degree of freedom, and the first degree of freedom are optimized by repeating the process until the optimized first degree of freedom, second degree of freedom, and third degree of freedom converge such that a relative attitude of the photographing device and the inertial measurement unit is obtained.

In some embodiments, the first degree of freedom, the second degree of freedom, and the third degree of freedom are respectively used to represent Euler angle components of the IMU. Alternatively, the first degree of freedom, the second degree of freedom and the third degree of freedom as described are respectively used to represent the axial angle components of the IMU. Further alternatively, the first degree of freedom, the second degree of freedom, and the third degree of freedom as described are used to represent the quaternion components of the IMU.

In some embodiments, the distance includes at least one of the following: European distance, city distance, and Mahalanobis distance.

The specific principles and implementations of the attitude calibration device provided by the embodiments of the present invention are similar to the embodiments shown in FIG. 6 and FIG. 7. Repetition is not elaborated here.

The embodiments herein presented according to the present disclosure provide the solutions of obtaining the relative attitude of the photographing device and the IMU by solving the first, second, and third degrees of freedom, calculating optimization in reiteration of the first degree of freedom, second degree of freedom and third degree of freedom, until the optimizations converge. This improves the accuracy of the relative attitude of the photographing device and the IMU.

An embodiment of the present invention provides an attitude calibration device. Based on the technical solution provided by the embodiment shown in FIG. 9, after the processor 92 obtains video data captured by photographing device, it is further configured to provide a rotation measurement result as the rotation information after the photographing device capturing video data. Then the attitude calibration device is configured to determine a relative attitude between the photographing device and the IMU based on the rotation measurement result and the captured video data.

In some embodiments, IMU acquires the angular velocity of the inertial measurement unit at a first frequency. The photographing device acquires image information at a second frequency during the process of capturing video data, wherein the first frequency is greater than the second frequency.

In some embodiments, when the processor 92 determines determining the rotation information of the IMU during the capturing of the video data by the photographing device based on the measurement result of the IMU which may be achieved by calculating integral of measurement results of the IMU from the first exposure of the first image frame to the second exposure time of the second image frame.

Specifically, the processor 92 may determine the rotation information of the IMU during the capturing of the video data by the photographing device based on the measurement result of the IMU, which may be achieved by calculating integral of measurement results of the IMU from the first exposure of the first image frame to the second exposure time of the second image frame. The detailed method of implement may include calculating integral of the angular velocity of the IMU from the first exposure time of the first image frame to the second exposure time of the second image frame.

Alternatively, the processor 92 may determine the rotation information of the IMU during the capturing of the video data by the photographing device based on the measurement result of the IMU, which may be achieved by calculating integral of measurement results of the IMU from the first exposure of the first image frame to the second exposure time of the second image frame. The detailed method of implement may include calculating product integral of the rotation matrix of the IMU from the first exposure time of the first image frame to the second exposure time of the second image frame.

Further alternatively, the processor 92 may determine the rotation information of the IMU during the capturing of the video data by the photographing device based on the measurement result of the IMU, which may be achieved by calculating integral of measurement results of the IMU from the first exposure of the first image frame to the second exposure time of the second image frame. The detailed method of implement may include calculating product integral of the quaternion of the IMU from the first exposure time of the first image frame to the second exposure time of the second image frame.

The specific principles and implementations of the attitude calibration device provided by the embodiment of the present invention are similar to the embodiment shown in FIG. 8, and details are not described herein again.

In the above described embodiment, the rotation information of the IMU, during the photographing process of the video data by the photographing device, may be determined by calculating integral of the measurement results. Since the results of the IMU can be substantially accurately obtained, calculating integral of the measurement results of the inertial measurement unit can accurately calculate the rotation information of the inertial measurement unit.

An embodiment of the present invention provides an unmanned aerial vehicle. FIG. 10 is a schematic diagram of an unmanned aerial vehicle according to an embodiment of the present invention. As shown in FIG. 10, the unmanned aerial vehicle (UAV) 100 includes a body, a power system, and a flight controller 118. The power transmission system, installed in the body, includes at least one of the following: a motor 107, a propeller 106 and an electronic speed controller 117. A flight controller 118 is communicatively connected to the power transmission system and is used to control the flight of the UAV.

In addition, as shown in FIG. 10, the unmanned aerial vehicle 100 further includes: a sensor system 108, a communication system 110, a supporting device 102, the photographing device, and an attitude calibration device 90. The supporting device 102 may be a gimbal and the communication system 110 may specifically include a receiver 116. The receiver 116 is configured to receive a wireless signal sent by an antenna 114 of ground stations 112. Receiver 116 indicates an electromagnetic wave generated during the communication between the receiver and the antenna 114. The shooting device 104 is used for shooting video data; the shooting device 104 and the IMU may be disposed on the same PCB, or the shooting device 104 and the IMU are rigidly connected. The specific principles and implementations of the attitude calibration device 90 are similar to the above embodiments described above and are not repeated here.

Those of ordinary skill in the art will appreciate that the example elements and algorithm steps described above can be implemented in electronic hardware, or in a combination of computer software and electronic hardware. Whether these functions are implemented in hardware or software depends on the specific application and design constraints of the technical solution. One ordinary skilled in the art can use different methods to implement the described functions for different application scenarios, but such implementations should not be considered as beyond the scope of the present disclosure.

For simplification purposes, detailed descriptions of the operations of example systems, devices, and units may be omitted, and references can be made to the descriptions of the example methods.

The disclosed systems, apparatuses, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit.

A method consistent with the disclosure can be implemented in the form of computer program stored in a non-transitory computer-readable storage medium, which can be sold or used as a standalone product. The computer program can include instructions that enable a computer device, such as a personal computer, a server, or a network device, to perform part or all of a method consistent with the disclosure, such as one of the example methods described above. The storage medium can be any medium that can store program codes, for example, a USB disk, a mobile hard disk, a read-only memory (ROM), a random access memory (RAM), a magnetic disk, or an optical disk.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A method of attitude calibration, comprising:
acquiring video data by a photographing device; and
determining a relative attitude between the photographing device and an inertia measurement unit (IMU) based on the video data and rotation information of the IMU in a time interval during which the video data is acquired.

2. The method of claim 1, wherein the rotation measurement information comprises at least one of the following:
a rotation angle, a rotation matrix, or a quaternion.

3. The method of claim 1, wherein the determining the relative attitude includes measuring the rotation information based on a rotation measurement of the IMU during the time interval between a first exposure moment of a first image frame and a second exposure moment of a second image frame, wherein the first image frame and second image frame are separated by a predetermined number of frames in the video data.

4. The method of claim 3, wherein the first image frame and second image frame are adjacent to each other in the video data.

5. The method of claim 3, wherein the acquiring the video data comprises,
performing a feature extraction from the first image frame and the second image frame;
identifying a first plurality of feature points of the first image frame and a second plurality of feature points of the second image frame;
obtaining a pair of matching first feature point and second feature point by performing a feature point matching of the first plurality of feature points of the first image frame and the second plurality of feature points of the second image frame.

6. The method of claim 5, wherein the acquiring the video data includes:
determining a position of a projection point of the first feature point in the second image frame and determining a distance between the position of projection point in the second image frame and the second feature point in the second image frame.

7. The method of claim 6, wherein the determining the position of the projection of the first feature point in the second image frame is based on a position of the first feature point in the first image frame, the rotation information of the IMU during the time interval between the first exposure moment of the first image frame and the second exposure moment of the second image frame, the relative attitude between the photographing device and the IMU, and internal parameters of the photographing device.

8. The method of claim 7, wherein the internal parameters of the photographing device comprise at least one of the following: the focal length of the photographing device and the pixel size of the photographing device.

9. The method of claim 6, wherein the determining the distance between the position of the projection point and the second feature point includes optimizing the distance between the position of the projection point and the second feature point.

10. The method of claim 9, wherein the optimizing the distance includes determining a relative attitude between the photographing device and an inertia measurement unit (IMU) by minimizing the distance between the projection position of the first feature point in the second image frame and the second feature point in the second image frame.

11. The method of claim 1, wherein a measurement result of the IMU is obtained when acquiring the video data, and the rotation information of the IMU is determined according to the measurement result.

12. The method of claim 11, wherein the rotation information of the IMU includes an angular velocity of the IMU being acquired at a first frequency, and the acquiring video data by the photographing device is conducted at a second frequency, the first frequency being greater than the second frequency.

13. The method of claim 1, wherein the rotation information of IMU is acquired by calculating an integral of the rotation information of the IMU from the first exposure moment of the exposure of the first image frame and the second exposure moment of the exposure of second image frame.

14. An unmanned aerial vehicle, comprising:
a body;
a power system mounted on the body for providing flight power;
a flight controller communicatively connected to the power system and configured to control flight of the unmanned aerial vehicle;
a photographing device configure to capture video data;
an inertia measurement unit (IMU) configured to provide rotation information of the IMU in a time interval during which the video data is acquired; and
an attitude calibration device configured to determine a relative attitude between the photographing device and the IMU based on the rotation information and the video data.

15. The unmanned aerial vehicle of claim 14, wherein the rotation measurement information comprises at least one of the following:
a rotation angle, a rotation matrix, or quaternion.

16. The unmanned aerial vehicle of claim 14, wherein the rotation measurement of the IMU is acquired during the time interval between a first exposure moment of the exposure of a first image frame and a second exposure moment of the exposure of a second image frame, wherein the first image frame and second image frame are separated by a predetermined number of frames in the video data.

17. The unmanned aerial vehicle of claim 16, wherein the first image frame and second image frame are adjacent to each other in the video data.

18. The unmanned aerial vehicle of claim 16, wherein the attitude calibration device is further configured to:
perform a feature extraction from the first image frame and the second image frame;
identify a first plurality of feature points of the first image frame and a second plurality of feature points of the second image frame; and
obtain a pair of matching first feature point and second feature point by performing a feature point matching of the first plurality of feature points of the first image frame and the second plurality of feature points of the second image frame.

19. The unmanned aerial vehicle of claim 14, wherein a measurement result of the IMU is obtained when acquiring the video data, and the rotation information of the IMU is determined according to the measurement result.

20. The unmanned aerial vehicle of claim 14, wherein the rotation information is an angular velocity obtained by the IMU at a first frequency; and
the photographing device is configured to capture the video data at a second frequency, the first frequency being greater than the second frequency.
